(19) United States
(12) Patent Application Publication
(10) Pub. No.: US 2026/0310043 A1
(43) Pub. Date: Oct. 8, 2026

(54) OPTICAL NEUROMORPHIC DEVICES WITH METAL HALIDE PEROVSKITE MATERIALS

(71) Applicants: Alliance for Energy Innovation, LLC, Golden, CO (US); Colorado School of Mines, Golden, CO (US)

(72) Inventors: Lance Michael WHEELER, Golden, CO (US); Andrew John FERGUSON, Louisville, CO (US); Nikhila BALASUBRAMANIAM, Cleveland, OH (US); Brodrick J SEVART, Golden, CO (US); Jeffrey Lee BLACKBURN, Golden, CO (US)

(21) Appl. No.: 19/303,298

(22) Filed: Aug. 18, 2025

Related U.S. Application Data
(60) Provisional application No. 63/684,171, filed on Aug. 16, 2024.

(51) Int. Cl. G02F 1/35; G06N 3/067

(52) U.S. Cl. CPC G02F 1/3515; G06N 3/067

(57) ABSTRACT

The present disclosure relates to a method that includes reversibly switching a perovskite between a δ-phase and an α-phase, where, when the perovskite is substantially in the δ-phase, the perovskite is capable of absorbing light at a first wavelength and emitting light at a second wavelength and when the perovskite is substantially in the α-phase, the perovskite is capable of absorbing light at the first wavelength and emitting light at a third wavelength.

### CROSS-REFERENCE TO RELATED APPLICATIONS

This application claims priority from U.S. Provisional Patent Application No. 63/684,171 filed on Aug. 16, 2024 and its associated appendix, the contents of which are incorporated herein by reference in their entirety.

### CONTRACTUAL ORIGIN

This invention was made with government support under Contract No. DE-AC36-08G028308 awarded by the Department of Energy. The government has certain rights in the invention.

### BACKGROUND

Neuronal emulation requires a new paradigm beyond implementation of neural network algorithms in conventional silicon circuitry, which is prohibitively expensive in terms of transistor count, time, and energy usage. Neuromorphic materials and devices offer opportunities to address impending challenges associated with collecting, processing, storing, and transmitting the vast quantities of complex data predicted for future computing needs. Optically addressable neuromorphic devices and systems hold promise for next generation visual perception applications and integrated photonic chips utilizing photons instead of electrons for computing. However, there remains a need for considerable research and development to make neuromorphic devices both technically and economically feasible.

### SUMMARY

An aspect of the present disclosure is a method that includes reversibly switching a perovskite between a δ-phase and an α-phase, where, when the perovskite is substantially in the δ-phase, the perovskite is capable of absorbing light at a first wavelength and emitting light at a second wavelength and when the perovskite is substantially in the α-phase, the perovskite is capable of absorbing light at the first wavelength and emitting light at a third wavelength.

In some embodiments of the present disclosure, the perovskite may have a composition according to Aₙ₊₁BₙX₃ₙ₊₁, where A is a first cation, B is a second cation, X is an anion, n can be reversibly transitioned between a first value of one and a second value of greater than one, the perovskite is substantially in the α-phase when n is greater than 7, and a mixture of the δ-phase and a two-dimensional (2D) crystalline phase is present when n is between 1 and 7, inclusively. In some embodiments of the present disclosure, n may be equal to a number of corner-sharing octahedral sheets present in the 2D crystalline phase. In some embodiments of the present disclosure, the perovskite may include FA, lead, and iodide.

In some embodiments of the present disclosure, the method may further include irradiating the perovskite with a light having the first wavelength, such that the δ-phase emits light at the second wavelength. In some embodiments of the present disclosure, the method may further include irradiating the perovskite with a light having the first wavelength, such that the α-phase emits light at the third wavelength. In some embodiments of the present disclosure, the method may further include an intervening molecule and a mixture, where the mixture includes the intervening molecule and at least one of the δ-phase, the α-phase, and/or the 2D crystalline phase.

In some embodiments of the present disclosure, the mixture may be positioned within a porous solid. In some embodiments of the present disclosure, the porous solid may include a solid and pores where the mixture is positioned within the pores. In some embodiments of the present disclosure, the δ-phase may exist when it is maintained at a first temperature and the α-phase may exist when it is maintained at a second temperature that is greater than the first temperature. In some embodiments of the present disclosure, the first temperature may be in a range between 15° C. and 25° C. In some embodiments of the present disclosure, the second temperature may be in a range between 25° C. and 150° C.

In some embodiments of the present disclosure, the solid may be constructed of a metal oxide. In some embodiments of the present disclosure, the porous solid may be between 25 vol % and 99 vol % empty volume relative to the total volume. In some embodiments of the present disclosure, the metal oxide may include at least one of an alumina, a titania, a tin oxide, a nickel oxide, a zirconium oxide, zinc oxide and/or a combination thereof.

In some embodiments of the present disclosure, the method may further include transmitting light from a light source to at least one of the perovskite, the solid, or a combination thereof via a first waveguide. In some embodiments of the present disclosure, the method may further include transmitting light emitted by the perovskite from the perovskite to a downstream device via a second waveguide. In some embodiments of the present disclosure, the light from the light source may be provided in pulses defined by a first period of time with the light on and a second period of time with the light off.

In some embodiments of the present disclosure, the method may further include cooling the perovskite from the second temperature to the first temperature. In some embodiments of the present disclosure, the cooling may be achieved by placing at least one of the mixture, the porous solid, or a combination thereof in physical conduct with a thermally conducting material.

### BRIEF DESCRIPTION OF DRAWINGS

Some embodiments are illustrated in referenced figures of the drawings. It is intended that the embodiments and figures disclosed herein are to be considered illustrative rather than limiting.

FIGS. 1A and 1B illustrate a perovskite in a corner-sharing, cubic phase arrangement, according to some embodiments of the present disclosure.

FIG. 2A illustrates three possible corner-sharing phases for perovskites, Panel A cubic phase (i.e., α-ABX₃), Panel B a tetragonal crystalline phase (i.e., β-ABX₃), and Panel C an orthorhombic crystalline phase (i.e., γ-ABX₃), according to some embodiments of the present disclosure.

FIG. 2B illustrates a perovskite in one of the three possible phases, the cubic phase (i.e., α-phase), compared to two non-perovskite phases (i.e., non-corner sharing), according to some embodiments of the present disclosure.

FIG. 3 illustrates 2D, 1D, and 0D perovskite-like structures, in Panels A, B, and C, respectively, according to some embodiments of the present disclosure.

FIG. 4 illustrates a representation of interconnected brain cells, i.e., neurons, including structures such as synapses, dendrites, and axons.

FIG. 5 illustrates theoretical aspects of a perovskite configured to behave as an optical neuromorphic device, according to some embodiments of the present disclosure.

FIG. 6 illustrates a method for using a perovskite as a neuromorphic device, according to some embodiments of the present disclosure.

FIG. 7 illustrates a schematic of a system used to test the ability of perovskite materials to act as neuromorphic devices, according to some embodiments of the present disclosure.

FIG. 8 illustrates the energetic transition when perovskite crystals transition between α-phase crystals and the δ-phase crystals, according to some embodiments of the present disclosure.

FIG. 9 illustrates the emission spectra for δ-phase and α-phase crystals, according to some embodiments of the present disclosure.

FIG. 10 illustrates the power dependence that continuous pumping (i.e., irradiating) has on the ability to switch to the α-phase, according to some embodiments of the present disclosure.

FIG. 11 illustrates photos of perovskite layers transition between phases, according to some embodiments of the present disclosure.

FIGS. 12A-12F illustrate experimental results from cycling repeated pulses of light to a perovskite, according to some embodiments of the present disclosure.

FIG. 13 illustrates results from a pseudo stochastic power train of varying pulse intensities of 15 seconds applied to a perovskite, according to some embodiments of the present disclosure.

FIG. 14 illustrates additional data of a perovskite's response to being irradiated by light, according to some embodiments of the present disclosure.

To facilitate understanding, identical reference numerals have been used, where possible, to designate identical elements that are common to the figures. It is contemplated that elements and features of one embodiment may be beneficially incorporated in other embodiments without further recitation.

### REFERENCE NUMERALS

| | |
|---|---|
| 100 | perovskite |
| 110 | A-cation |
| 120 | B-cation |
| 130 | X-anion |
| 600 | method |
| 610 | mixture |
| 620 | δ-phase |
| 630 | 2D/α-phase |
| 640 | intervening molecule |
| 650 | incident light |
| 655 | light emitted by δ-phase |
| 656 | light emitted by 2D/3D phase |
| 690 | switching |
| 700 | composite |
| 710 | porous solid |
| 720 | solid |
| 730 | pore |
| 690 | switching |

### DETAILED DESCRIPTION

The present disclosure relates to all-optical artificial neurons with leaky-integrate-and-fire behavior based on perovskites. The perovskites act as a phase change material, thereby providing optical memory. As shown herein, optical neuromorphic devices and systems based on perovskites provide several advantages over incumbent technologies, e.g., chalcogenides, including tunable threshold potentials and volatilities. As used herein, the term “volatility” is defined with regards to the stability of a particular phase that is accessed by a given set of stimuli. A fully “non-volatile” optical memory would result from a phase change that does not relax back to the original phase when the stimuli are halted. Outside of this hypothetical extreme (i.e., infinite phase lifetime), the degree of volatility increases with decreasing lifetime of a given phase that is programmed by a set of stimuli.

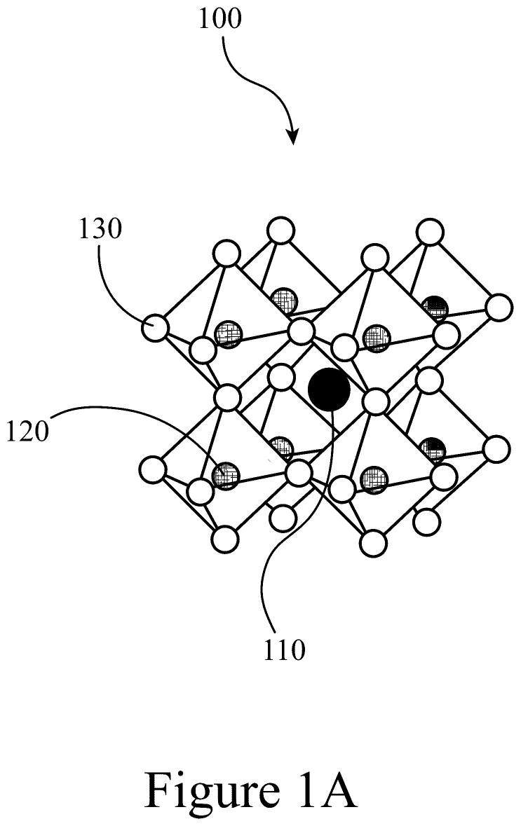

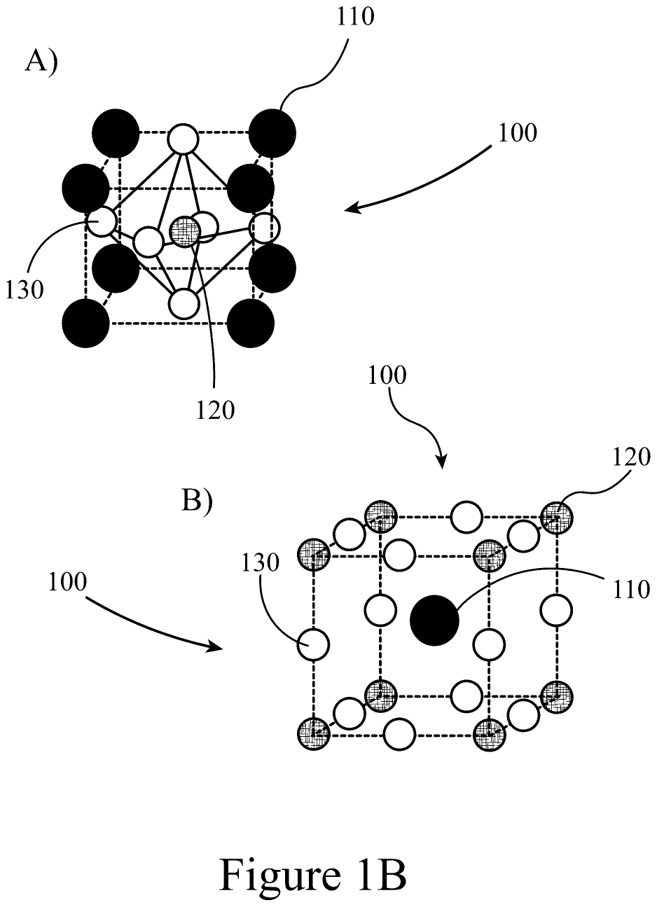

In general, the term “perovskite” refers to compositions having a network of corner-sharing BX₆ octahedra resulting in the general stoichiometry of ABX₃. For example, metal halide perovskites, may organize into three-dimensional (3D) cubic or near-cubic symmetry crystalline structures constructed of a plurality of corner-sharing BX₆ octahedra (see FIG. 1). In the general stoichiometry for a perovskite 100, ABX₃, X is an anion 130 and A and B are cations, 110 and 120, respectively, typically of different sizes. A perovskite may have an α-phase structure characterized by eight BX₆ octahedra surrounding a central A-cation, where each octahedra is formed by six X-anions surrounding a central B-cation, where each of the octahedra are linked together by “corner-sharing” of anions, X.

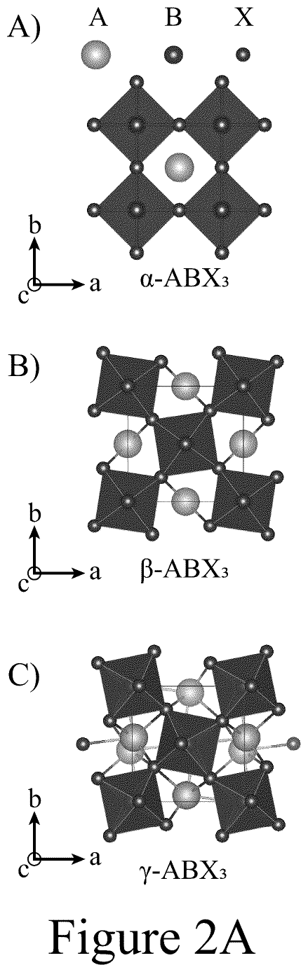

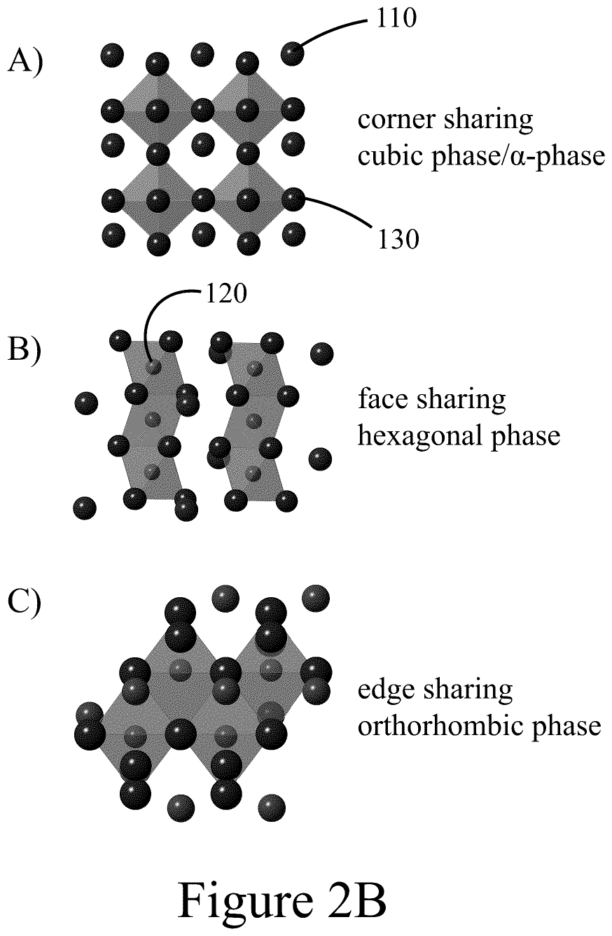

However, a perovskite can assume other crystal systems while still maintaining the criteria of an ABX₃ stoichiometry with neighboring BX₆ octahedra connected by X anion corner-sharing (see FIG. 2A). Thus, in addition to perovskites in the cubic phase having a tilt angle of 180 degrees, a perovskite may also assume and interconvert between a tetragonal crystalline phase and/or an orthorhombic crystalline phase, where the adjacent octahedra are tilted relative to 180 degrees (e.g. reversible phase changes in response to temperature). Further, the elements used to construct a perovskite, A-cations, B-cations, and X-anions, may result in 3D non-perovskite structures; i.e., structures where neighboring BX₆ octahedra are not X-anion corner-sharing and/or do not have a unit structure that simplifies to the ABX₃ stoichiometry (see FIG. 2B). Examples include a non-perovskite structure constructed of face-sharing BX₆ octahedra resulting in a hexagonal crystalline structure and a non-perovskite structure constructed of edge-sharing BX₆ octahedra resulting in a variety of lower symmetry hexagonal, trigonal, monoclinic, or triclinic crystalline structures. A plethora of materials related to the perovskite material family may also include mixed BX₆ linkages within the same crystal structure, including face-, edge-, and corner-sharing, whether intentionally targeted structures or as a result of high defect density (e.g. twin boundaries) within a predominantly cubic perovskite material.

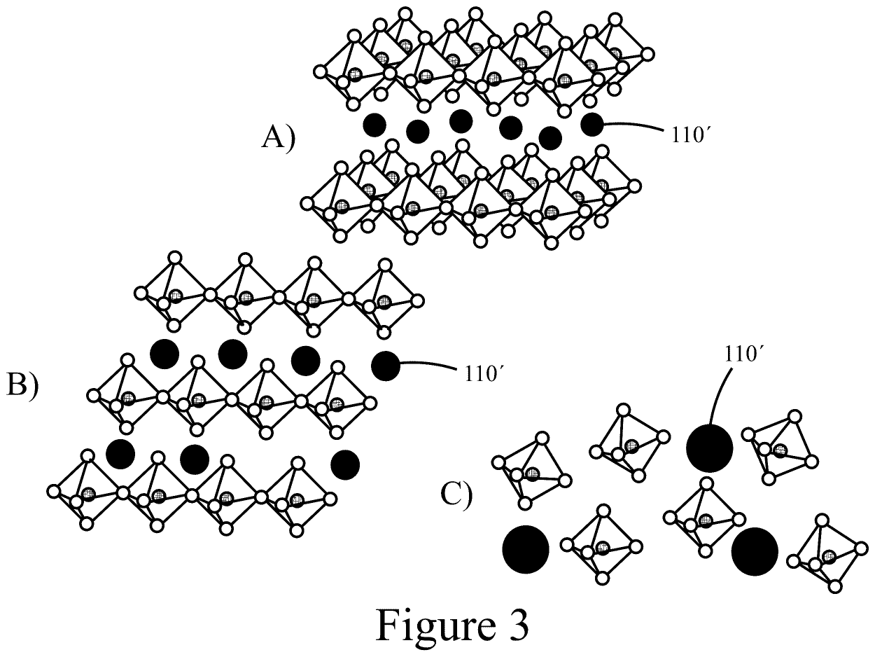

In addition, the elements used to construct a perovskite, as described above, A-cations, B-cations, and X-anions, may result in non-3D (i.e., lower dimensional structures) perovskite-like structures such as two-dimensional (2D) structures, one-dimensional (1D) structures, and/or zero-dimensional (0D) structures (see FIG. 3). Such lower dimensional, perovskite-like structures still include BX₆ octahedra, and depending on the dimensionality, e.g., 2D or 1D, may still maintain a degree of X-anion corner-sharing. However, the X-anion corner-sharing connectivity of neighboring octahedra of such lower dimensional structures, i.e., 2D, 1D, and 0D, is disrupted by A-cations and/or other molecules such as water. Such a disruption of the neighboring octahedra can be achieved by, among other things, varying the size of the A-cations and/or the presence of intervening molecules such as water. Thus, referring again to FIG. 3, a perovskite composition can reversibly transition through the various dimensionalities (3D, 2D, 1D, and/or 0D) as a result of changes to the local environmental conditions, such as temperature and/or humidity.

As shown in FIG. 3, 0D perovskites may have isolated [BX₆]⁴⁻ octahedra. A perovskite precursor, e.g. an AX salt unit, may be removed from an 0D perovskite-like material to form a 1D perovskite-like material, which have octahedra connected to form metal halide chains. Removing another AX salt pair unit from a 1D perovskite yields a 2D perovskite-like material where metal halide octahedra are connected in planes (i.e. layers) where n is the number of metal halide octahedra layers. Subsequently, when partial units of AX salt (n(n+1)⁻¹) are removed from a 2D perovskite-like material, a 2D structure with layers of 3D perovskite may be formed. When n>3, 3D perovskites are formed with octahedra units that share all of their halide atoms with adjacent octahedra. As additional AX salt pairs (i.e. perovskite precursors) are removed, and as n approaches ∞, all octahedra units share their corner halide atoms with adjacent octahedra to form a 3D perovskite with the general form ABX₃. This physical change through a continuum starting with a 1D perovskite-like material transitioning through a 2D material to a 3D perovskite may be represented by the equation Aₙ₊₁BₙX₃ₙ₊₁. As n approaches ∞, the equation approaches ABX₃ for a 3D perovskite.

Further, a result of these materials transitioning through different crystalline forms and dimensionalities, their light absorption spectra also change; as the dimensionality increases, the perovskite changes from more transparent to more opaque in the visible portion of the spectrum. As a perovskite structure is transformed from a 0D crystalline form to a 3D crystalline form, the optical bandgap of the material may be reduced. 0D structures often absorb strongly in the ultraviolet portion of the electromagnetic spectrum, but typically absorb little to no visible light, whereas 1D and 2D materials may absorb some portion of the visible spectrum. In other words, as a perovskite moves from a lower dimensional crystalline form to a higher dimensional crystalline form, the perovskite demonstrates chromism by moving through a continuum of visible light transparency and opacity, starting with a substantially transparent 0D perovskite and ending with a substantially opaque 3D perovskite. 3D perovskites in the cubic phase (a-ABX₃) with axially aligned octahedra have the narrowest optical band gap and are the most opaque. Further, a 3D perovskite in the cubic phase may be reversibly transformed by adding energy to the system, which results in tilting the octahedra of the perovskite relative to a first reference axis (see FIG. 2A). 3D perovskites with tilted octahedra may be in the tetragonal phase (β-ABX₃), which reduces crystal symmetry, widens the bandgap, and increases the transparency of the perovskite. Tilting the octahedra along a second axis yields the orthorhombic phase (γ-ABX₃), further reducing symmetry, widening the bandgap, increasing the transparency of the perovskite (see FIG. 2A). Finally, ABX₃ perovskites, with the addition of energy, may undergo a reversible phase transition to form the 3D phase (δ-ABX₃), which takes two possible symmetry forms: hexagonal (P63/mmc) and orthorhombic (Pnma). Both forms have wide bandgaps and absorb less visible light than their higher dimensional counterparts. Both forms have wide bandgaps and absorb less visible light than their higher dimensional counterparts.

Finally, the discrete optical transitions observed in the absorbance spectra occur due to the separation or coalescence of 1D octahedra layers. The optical bandgap of Aₙ₊₁BₙX₃ₙ₊₁ materials increases monotonically as n approaches 1 due to formation of minibands in the quantum well superlattice structure that emerges due to alternating layers of formamidinium and connected lead halide octahedra layers. Generally, as n increases from n equal to 1 corresponding to a 1D perovskite-like material to n having a value much greater than 1 such that the material is essentially entirely ABX₃, e.g., 3D material, both the absorption spectra and the photoluminescence spectra increase in wavelength. For example, a 1D perovskite material typically absorbs UV light (wavelength between 100 nm and 400 nm) and emits light in the green region of the visible spectrum (~495-570 nm), whereas 2D and 3D materials tend to both absorb and emit in the blue to red wavelength range (~400 nm to ~700 nm) range, with a redshift occurring as n increases in value. As described herein, these characteristics of perovskites are manipulated to produce optical neuromorphic devices, e.g. memristors.

For simplification, the term “perovskite” is used herein to include corner-sharing crystal structures, and non-corner-sharing crystal structures, as well as each of 3D, 2D, 1D, and 0D crystal structures, even though, technically a perovskite is characterized by a 3D crystal structure.

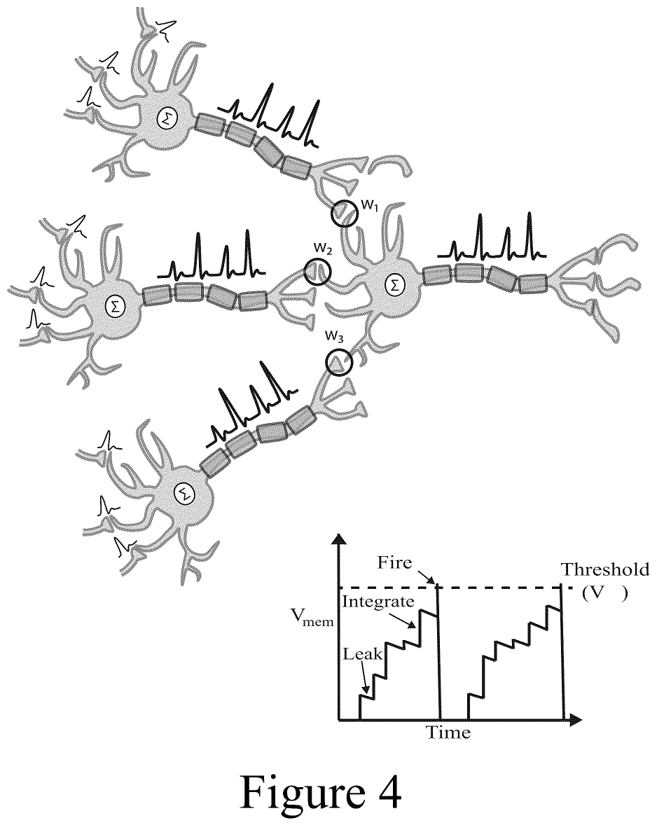

When it comes to replicating human intelligence and the ability to dynamically process large amounts of information, the two primary targets for neural mimicry are the synapse and the neuron. As illustrated in FIG. 4, the synapse is the interface between brain cells which acts as a bridge for electrical signals to be transferred. These synapses have a key feature known as the synaptic weight (wₙ) which modulate the intensity of the signal sent between brain cells, the greater the synaptic weight the more important that signal is to downstream brain cells. The brain cells form a large neuronal network of cells which receive and send signals to multiple other cells. The electrical signals leave the axons of the brain cells which are strengthened by the myelin sheath. These presynaptic signals/spikes then cross the synapse where the intensity of the signal is modulated based on the synaptic weight. The postsynaptic spike which leaves the synapse, travels up the dendrite, and is then integrated along with other postsynaptic spikes from other dendrites. This integration occurs in the central body of the neuron where the electrical potential is integrated. However, “leakage” or a decrease in electrical potential can occur when metal ions migrate back across the cell membrane in a process which is slower than the integration as seen in the plot of Vₘₑₘ versus time in FIG. 4. Once the electrical signal reaches a certain threshold, an output spike is propagated or fired downstream to the next set of neurons in the network. This concept is often denoted as a leaky-integrate-and-fire model which is used to describe the overall functionality of signal propagation through the vast neural network which compromises mammalian central nervous systems, including the brain.

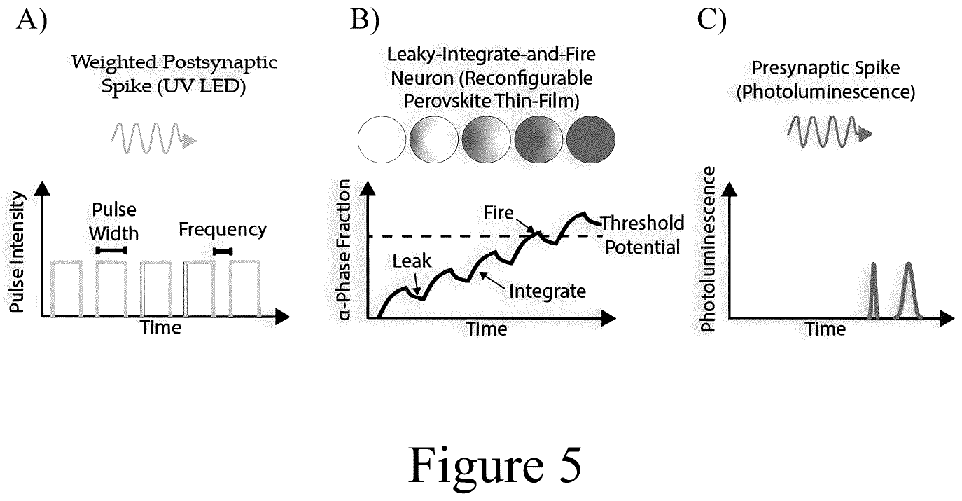

Referring to FIG. 5, as shown herein, perovskites can be used to synthesize all-optical artificial neurons having leaky-integrate-and-fire characteristics that mimic natural neurons (hypothetical scenario illustrated). As described above, this may be achieved by the transition of a perovskite material between phases, i.e., crystal structures 1D to 3D, as n increases from 1 to approaching infinity, according to Aₙ₊₁BₙX₃ₙ₊₁. Referring to Panel B) of FIG. 3 illustrating a 1D perovskite-like material and FIG. 1 illustrating a 3D perovskite, a perovskite can be reversibly transitioned from a first phase, a 1D δ-phase perovskite-like material, to a 3D α-phase perovskite. This transition can occur, where instead of integrating incoming electrical signals to reach a threshold as shown in FIG. 4 for a natural neuron, light may be used as an input signal as shown in Panel A of FIG. 5, by utilizing the tendency of perovskites to reversibly incorporate water causing the reversible transition between the 1D δ-phase perovskite-like material and the 3D α-phase perovskite.

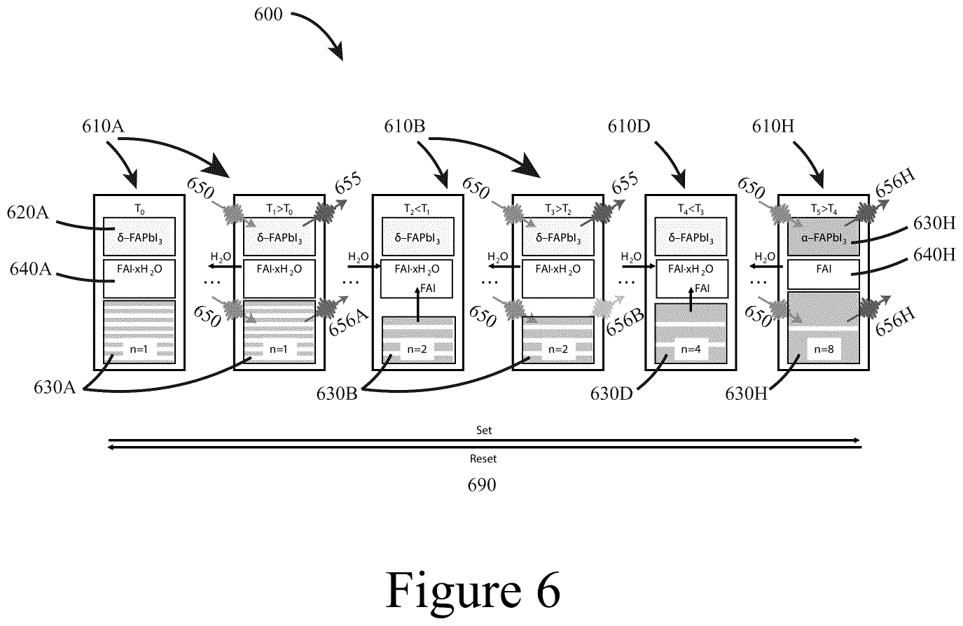

FIG. 6 illustrates a method 600 that utilizes these principles for operating a perovskite based neuromorphic device, according to some embodiments of the present disclosure. The central component is a perovskite that is capable of being reversibly switched between a one-dimensional (1D) δ-phase and a three-dimensional (3D) α-phase. As demonstrated by this work, the perovskite may be reversibly switched through a continuum of phases as defined by Aₙ₊₁BₙX₃ₙ₊₁, starting at a first end-point when n is equal to one and a second endpoint as n reaches a value of about 6, 7, or 8. Referring to FIG. 6, for each value of n, the perovskite is present in a mixture 610 that includes a first portion of the perovskite in the δ-phase 620 and a second portion of the perovskite that includes at least one of a two-dimensional (2D) perovskite-like material and/or 3D α-phase. This second portion is referred to herein as a “2D/α-phase” with reference number 630. A third component of a mixture 610 is an intervening molecule 640, which itself is a mixture of at least one of AX molecules and/or water molecules. When n is equal to one, a first mixture 610A includes a δ-phase 620A, a 2D/α-phase 630A, and intervening molecules 640A. The 2D/α-phase 630A includes a plurality sheets, where each sheet contains only one layer of corner-sharing octahedra (see Panel A of FIG. 3). As n increases the thickness of each sheet increases by one additional layer of corner-sharing octahedra. So, referring again to FIG. 6, when n is equal to two, the mixture 610B includes a δ-phase 620B, a 2D/α-phase 630B, and intervening molecules 640B, where the 2D/α-phase 630B contains a plurality of sheets where each sheet contains two layers of corner-sharing octahedra. Similarly, when n is equal to four, the mixture 610D includes a δ-phase 620D, a 2D/α-phase 630D, and intervening molecules (not called out), where the 2D/α-phase 630D contains a plurality of sheets where each sheet contains four layers of corner-sharing octahedra. Finally, referring again to FIG. 6, when n is equal to eight, the δ-phase no longer exists and the mixture 610H only includes intervening molecules 640H (e.g., AX as FAI) and a 2D/α-phase that is essentially 3D α-phase because the layers of corner-sharing octahedra are thick enough, eight layers of corner-sharing octahedra, that its behavior (e.g., absorption and emission spectra) is essentially identical to “pure” α-phase corresponding to very large values of n (e.g., n>100).

Referring again to FIG. 6, the spectroscopic behavior of the δ-phase 620 and the 2D/α-phase 630 and, eventually, an essentially pure 3D α-phase also move across a continuum as n increases from one. As illustrated, irradiating a first mixture 610A with incident light 650 may result in at least two wavelengths of light being emitted, first, a light 655 emitted by the δ-phase 620A and, second, a light 656A emitted by the 2D/α-phase 630A. As n is increased, the amount of light 655 emitted by the δ-phase 620 gradually lessens and eventually disappears when the perovskite is completely converted to 3D α-phase. On the other hand, the 2D/α-phase 630 is transformed from a plurality of 2D sheets that are initially relatively thin (e.g., only a single layer of corner-sharing octahedra) to progressively thicker 2D sheets that eventually approximate and become essentially entirely 3D α-phase. Therefore, when n is equal to one, the 2D/α-phase 630A may emit light 656A at a different wavelength than that emitted by the δ-phase 620A. However, as n is increased, e.g. to between 2 and 7, the light 655 emitted by the δ-phase 620 will lessen in intensity while the light 656 emitted by the 2D/α-phase 630 will red-shift to approach the light emitted by pure 3D α-phase.

As energy is added to the system, e.g., in the form of heat, the perovskite's average temperature may increase from a relatively cool starting temperature between 15° C. and 25° C. to a relatively high end temperature. As energy is added to the perovskite, and as the temperature increases, intervening molecules 645, e.g., water may be removed from the mixture 610, enabling AX intervening molecules 640 to be transferred from the δ-phase 620 to the 2D/α-phase 630 contained in the mixture 610, enabling layers of corner-sharing octahedra to coalesce into thicker octahedra sheets. Referring again to FIG. 6, as additional energy is added and as the temperature is further increased, intervening water molecules may continue to be removed the mixture 610 and AX transferred from the from δ-phase 620 to the perovskite 2D/α-phase 630, resulting in the may transition through the continuum of intermediate phases described above, with each successive 2D/α-phase 630 constructed of successively thicker layers. Eventually, a second endpoint on the continuum, a steady-state from the perspective of absorption and emission spectra, is achieved when the majority of water intervening molecules have been removed from the mixture, essentially all AX intervening molecules have been incorporated into a 3D α-phase, and the mixture only emits light at one wavelength. This final condition may be achieved when a final relatively warm temperature between 30° C. and 150° C. is achieved, and the perovskite is essentially entirely 3D perovskite having a stoichiometry of ABX₃.

Referring again to FIG. 6, both a δ-phase 620 of the perovskite and a 2D/α-phase 630 are capable of absorbing light and emitting light (photoluminescence). This is true for all of the mixtures on the continuum of phases between the δ-phase 620 and the 2D/α-phase 630, for n greater than or equal to one. The specific wavelengths of light absorbed and emitted by a particular phase will at least partially depend on the specific composition, e.g., choice of A-site cations, B-site cations, and X-site anions. However, in general both ranges for absorbed light and emitted light shift from shorter wavelengths to longer wavelengths with increasing values of n. More specifically, a 1D perovskite-like phase, like a δ-phase, absorbs light in the ultra-violet (UV) range of the spectrum (in the range between 100 nm and 400 nm) and emits light in the green region of the visible spectrum (in the range between 495 nm and 570 nm). On the other end of the continuum, a 3D perovskite, like a 3D α-phase, absorbs light in the blue region of the visible spectrum (in the range between 400 nm and 500 nm) and emits light in the red region of the visible spectrum (in the range between 450 nm and 750 nm). These characteristics, a perovskite material capable of transitioning through different crystalline phases, with each phase identifiable by a signature light absorption spectrum and emission spectrum, make perovskite materials uniquely suited for synthesizing optical neuromorphic devices that mimic the leaky-integrate-and-fire behavior of natural neurons, as shown below.

Referring Panel B of FIG. 5 and comparing it to the graph illustrated in FIG. 4 for a natural neuron, due to the absorptive characteristics of a perovskite, a perovskite-based neuromorphic device may utilize light to simulate an incoming electrical signal (Vₘₑₘ). Thus, light provides a controllable energy input into the perovskite, controllable by independent variables including the pulse width and frequency of the light being used to irradiate the perovskite (see Panel A of FIG. 5), as well as the intensity of the light. Light pulses, therefore, can be used to gradually increase the temperature of a perovskite, causing the gradual change to the crystal structure of the perovskite and to the perovskite's absorption spectra and emission spectra. As shown in Panel B of FIG. 5, the leaky-integrate-and-fire behavior can be produced by controlling the energy input into the perovskite by the absorption of light, with the “leaky” nature achievable by cooling the perovskite. The threshold potential to initiate a “firing” by the perovskite may be indicated by the characteristic emission spectrum defined by the second phase 640, which for the case of 3D FAPbI₃ perovskite having a predominantly α-phase, is in the range between 650 nm and 750 nm (fourth wavelength 665) when irradiated with UV light at about 365 nm (third wavelength 660). Such a “presynaptic spike”, a light emission spike from the perovskite resulting from a pulse of incoming light, is illustrated in Panel C of FIG. 5. Panel B of FIG. 5 illustrates the wide flexibility offered by a perovskite system for designing neuromorphic devices, e.g., memristors. A δ-phase 620 and a 2D/α-phase 630, and their corresponding absorption spectra and emission spectra, can be selected anywhere along the continuum from n equal to 1 and a δ-phase to a 3D α-phase, e.g., an intermediate value of n may be selected for at least one of a starting point and/or a threshold for firing. This enables the amount of “integration” needed to cause a “firing” (e.g., emission of a characteristic wavelength) to be adjusted as needed for a specific application. Further, the amount of integration that occurs per pulse of incoming light may also be controlled and this can be done “on the fly” by instantaneous changes to at least one of the wavelength of the incoming light, its intensity, the light pulse width, frequency, etc. Similarly, the “leakage” rates may be controlled by controlling the amount of cooling provided to the perovskite; e.g., supplementing natural cooling with additional cooling provided by a thermoelectric cooling device, providing convective cooling through the use of a cooled gas stream, and/or by radiative cooling effects. The combination of all of these components results in a perovskite-based memristor that has the capability of providing an analog output versus the binary output of a simple switch.

Referring again to FIG. 6, a perovskite-based memristor's leaky-integrate-and-fire behavior can be tuned by manipulating the composition of the perovskite. In some embodiments of the present disclosure, an A-site cation may include at least one of formamidinium (FA), methylammonium (MA), ethylammonium, diethylammonium, guanidinium, or a combination thereof. In some embodiments of the present disclosure, a B-site cation may include at least one of bismuth, antimony, copper, nickel, lead, tin, or a combination thereof. In some embodiments of the present disclosure, an X-site anion may include at least one of a halide, a pseudohalide, or a combination thereof. In some embodiments of the present disclosure, an X-site anion may include iodide, bromide, chloride, or a combination thereof. In some embodiments of the present disclosure, a perovskite designed for a memristor will include FA, lead, and iodide.

In some embodiments of the present disclosure, irradiating a perovskite substantially in a δ-phase with a light having the first wavelength may result in the δ-phase emitting light at a second wavelength, where the second wavelength is greater than the first wavelength. In some embodiments of the present disclosure, a first wavelength may be in a range between 100 nm and 400 nm. In some embodiments of the present disclosure, a second wavelength of light may be in a range between 495 nm and 570 nm. In some embodiments of the present disclosure, irradiating a perovskite substantially in a 2D/α-phase with a light having the third wavelength may result in the 2D/α-phase emitting light at the fourth wavelength, where the fourth wavelength is greater than the third wavelength. In some embodiments of the present disclosure, a third wavelength may be in a range between 10 nm and 650 nm. In some embodiments of the present disclosure, a fourth wavelength may be in a range between 450 nm and 750 nm. In some embodiments of the present disclosure, a third wavelength may be equal to a first wavelength. The energy input provided by light irradiating the perovskite may be controlled by controlling aspects of pulsed light (see FIG. 5), for example a first period of time corresponding to how long a light source is on and a second period of time corresponding to how long a light source is off. In some embodiments of the present disclosure, a first period of time may be in a range between 0.1×10⁻³ seconds and 100 seconds. In some embodiments of the present disclosure, a second period of time may be in a range between 0.1×10⁻³ seconds and 5 minutes. In some embodiments of the present disclosure, the energy input to a perovskite-based memristor may be at least partially controlled by the power provided by the light irradiating the material. In some embodiments of the present disclosure, the power input provided by light irradiating the material may be in a range between 1×10⁻⁶ mW and 100 mW.

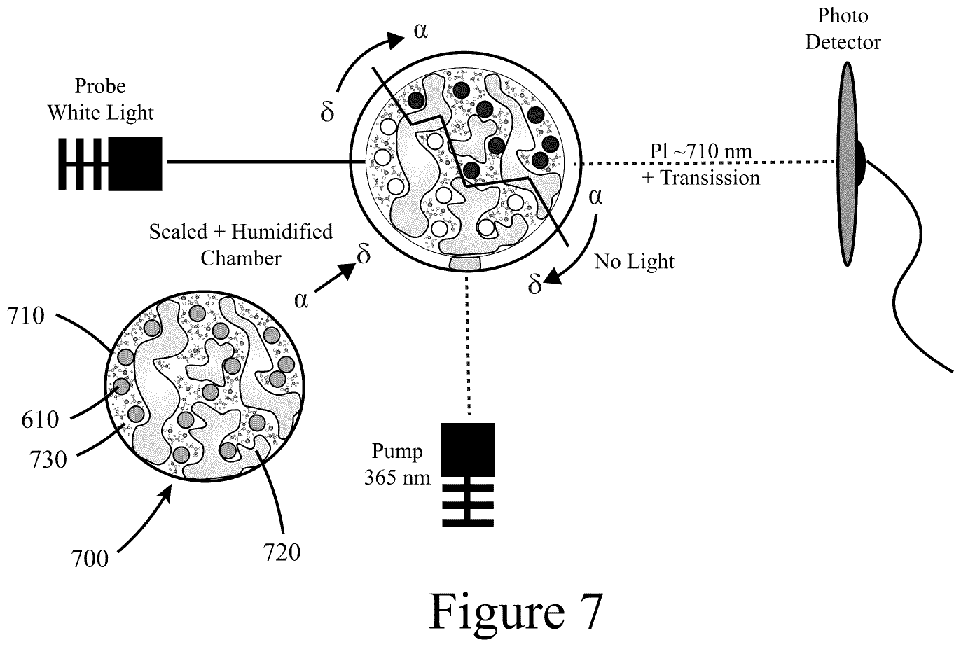

As stated above, a perovskite may be positioned with the pores of a porous solid. This embodiment of the present disclosure is illustrated in FIG. 7, which shows a composite 700 constructed of a porous solid 710, a solid 720 having a plurality of pores 730. A mixture 610 (i.e., a δ-phase 620, a 2D/α-phase 630, etc.) is positioned with the pores 730 of the porous solid 710. In some embodiments of the present disclosure, the solid 720 of a porous solid 710 may be constructed of a metal oxide. In some embodiments of the present disclosure, a metal oxide used for a porous solid may include at least one of an alumina, a titania, zirconia (e.g., ZrO₂), tin oxide (e.g., SnO₂), nickel oxide (e.g., NiO) or a combination thereof. In some embodiments of the present disclosure, the solid 720 of porous solid is Al₂O₃ and/or TiO₂. In some embodiments of the present disclosure, the pores 730 of a porous solid 710 may be between 25 vol % and 9 vol % of the composite solid's total volume.

Besides providing a container to hold the perovskite in a convenient fashion, a porous solid 710 may be configured to absorb the light being used to reversibly switch a perovskite from a first phase to a second phase. For example, the solid of a porous solid may be selected that absorbs the wavelengths of light chosen to irradiate the perovskite/porous solid composition, balanced with a suitable heat-capacity, preferably low, that enables quick temperature changes to the solid and, subsequently to the perovskite. As the temperature of the solid increases, the resultant temperature gradient with the perovskite, will result in heat transfer from the solid, e.g., alumina, to the perovskite, thus raising the perovskite temperature as well. The increase in the perovskite's bulk temperature will subsequently change the perovskite's phase such that it moves towards the phase designated as the “threshold phase”, which when attained, is signaled by the corresponding emission spectrum and/or wavelength. In addition to heat-capacity, the thermal response of a perovskite/porous solid composite to periods of having a light source on and off can be affected by the mass of the composite and/or thickness of the composite. In some embodiments of the present disclosure, a composite of a perovskite/porous solid may be in the form of a layer having a thickness in a range between 15 nm and 10 μm.

As the average bulk temperature of the perovskite is a key control variable for affecting the phase of the perovskite, a method/system for controlling this temperature is another aspect of the present disclosure. For a given amount of intervening molecules (e.g. water and excess AX), a first phase will exist while a first temperature range is maintained and a second phase will exist while a second temperature range is maintained, where the second temperature is typically higher than the first temperature. In some embodiments of the present disclosure, a first temperature for maintaining a first phase may be in a range between 10° C. and 65° C. In some embodiments of the present disclosure, a second temperature for maintaining a second phase may be in a range between 20° C. and 40° C.

In some embodiments of the present disclosure, a perovskite-base memristor may utilize a first wave guide for transmitting light from a light source to at least one of the perovskite, the solid, or a combination, for example a fiber optic cable or an on-chip waveguide (e.g., silicon nitride—SiN—waveguides commonly used in telecommunications technologies). Further, a perovskite-base memristor may utilize a second wave guide, e.g., optical fiber, for transmitting light emitted by the perovskite from the perovskite to a downstream device.

The perovskite-containing devices described above have potential to serve in a variety of applications. For example, the information content provided by the device switching response may be increased by performing “multiplexing” at different detection wavelengths. In this multiplexing mode, the emission from a layer of perovskite may be passed through multiple channels, each of which is configured to detect a separate wavelength or narrow wavelength range. Since the layer progresses through a series of phases with varying dimensionality, phase composition, and corresponding average bandgap, the emission spectrum of the layer evolves in terms of its breadth (i.e. width of the wavelength range) and peak emission wavelength. Simultaneously measuring different wavelengths that span this range of emission wavelengths can allow for a more complete reconstruction of the information encoded by a given set of stimuli at a given set of time than can be gleaned from measuring at a single wavelength. Separation of the emission into the different channels can be achieved in different ways. As an example, a diffraction optic can be used to separate the emission wavelengths from a broad emission envelope spatially, allowing the different wavelengths (or wavelength ranges) into separate collection channels, each of which is defined by a separate detector (that could be coupled to a fiber or waveguide).

In summary, a perovskite layer may be “switched” from a starting essentially transparent δ-phase to an essentially opaque α-phase by heating the δ-phase, resulting in the transitioning through various intermediate phases, as described above. The heating essentially removes intervening molecules separating the 2D sheets making up the perovskite-like δ-phase, enabling the 2D sheets to coalesce into the 3D α-phase perovskite. Such a transition may occur gradually over a continuum defined by the starting point, the perovskite-like δ-phase, to the end point, the α-phase perovskite. Upon cooling, the opaque α-phase perovskite may revert back to the transparent perovskite-like δ-phase. Heating may be achieved in a controllable fashion by irradiating the perovskite with light with cooling achieved by removal of the light. As described herein, pulses of UV LED (365 nm) were supplied to a cooled perovskite in the transparent δ-phase, to simulate postsynaptic spikes. Each UV pulse may be absorbed by the δ-phase material, resulting in the gradual, step-change-like heating of the material and resultant gradual step-change-like transition from the cooled δ-phase material to the warmed, opaque, 3D α-phase perovskite. This progressive transition from δ-phase to α-phase can be viewed as the integration process described above for organic neurons.

In an exemplary system, a thin layer, about 1.5 μm, of FAPbI₃ (FA=formamidinium), an organic metal halide perovskite which, as shown herein, can function as an integrating neuron by varying the perovskite's phase concentration (of δ-phase and α-phase) in the layer. The layer of FAPbI₃ also included an excess ratio of FAI of normally 2.5×-4× the number of PbI₂ moles. Note that excess AX, e.g., FAI, enable more α-phase to be generated as n is increased; e.g., excess FAI forms adjacent phases composed of layered corner-sharing octahedra

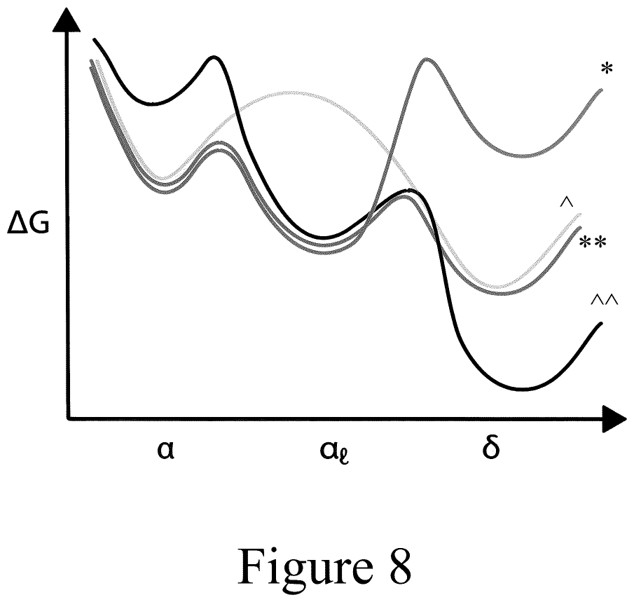

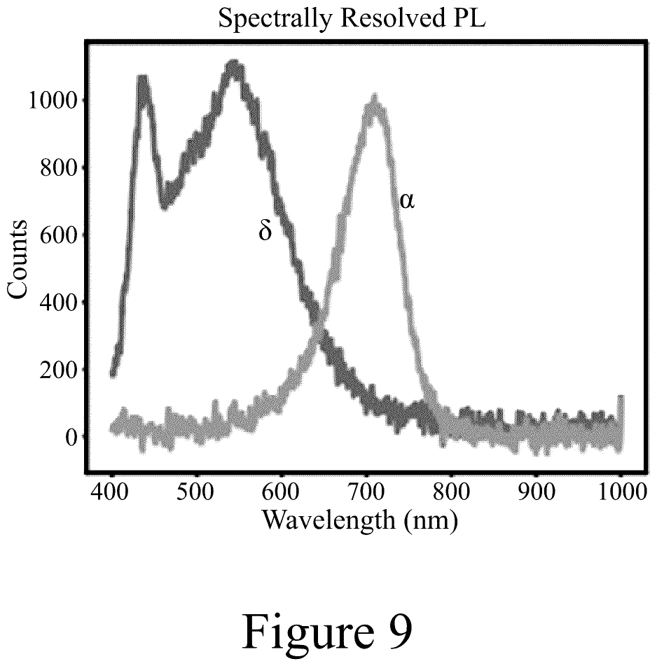

The physical set up for these FAPbI₃ devices is illustrated in FIG. 7. Experiments began with dehydrated α-phase crystals (i.e., opaque second phase 640) positioned in an alumina scaffolding (i.e., porous solid 620) which were then initially converted to the δ-phase (i.e., transparent first phase 630) by sealing the layer of composite perovskite 100/porous solid 620 in a humidified chamber where the relative humidity was maintained above a threshold in by adding a solution of supersaturated KCl, which maintained the relative humidity (RHO above 80%. Upon irradiating the transparent first phase 630 with 365 nm light (i.e., first wavelength 650), the δ-phase crystals (transparent) reconfigured to α-phase crystals (opaque), which began to emit 450 nm (δ-phase) and 550 nm (layered phase). The energetic transition for this transition between δ-phase crystals and α-phase crystals is illustrated by FIG. 8 where dehydrated perovskite crystals (*) favor the α-phase crystal (opaque) and planar α-phase sheets. Upon hydrating (**), the δ-phase (transparent) is stabilized and becomes more favorable, irradiating the perovskite with pulses of light added energy and allows for emission from the α-phase crystals and planar sheets, however, upon high energy input (\hat{ }) the α-phase planar sheets are no longer accessible. When even more energy was inputted into the system, coalescence (\hat{ }\hat{ }) of the crystals occurred, which trapped the α-phase crystals and the δ-phase crystals into their own respective energy wells. It should be noted that both the δ-phase and α-phase crystals emitted light, as illustrated in FIG. 9. While irradiating with 365 nm light can result in the emission from whichever phase is in the layer, one cannot monitor the fraction of α-phase crystals in the layer when the layer is not actively being irradiated. However, as illustrated in FIG. 7, irradiating the perovskite separately with white light can be used to monitor the change in transmission between the highly transmissive (transparent) δ-phase and highly absorbative (opaque) α-phase.

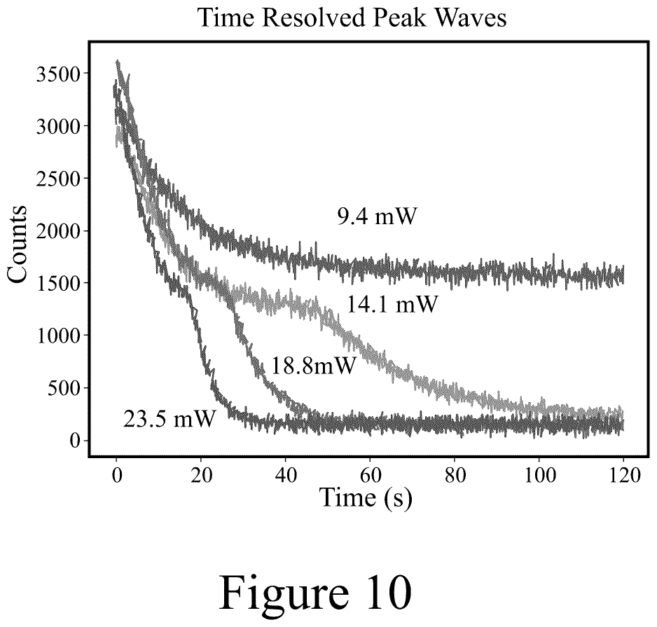

One interesting aspect of the present disclosure, is the ability for presynaptic pulses to initiate conversion to the α-phase and the relationship of subsequent firing to the pulse intensity and switching. FIG. 10 illustrates the power dependence that continuous pumping has on the ability to switch to the α-phase. Here the change in transmission was monitored by applying a white light. The lowest power applied, 20 mA, was the only power which did not convert the starting δ-phase to the α-phase and, instead, followed an initial reduction in transmission and only PL from the δ-phase occurs. In contrast, the 30 mA, 40 mA, and 23.5 mW were able to fully convert the starting δ-phase to the α-phase while emitting from the δ-phase, but in shorter and shorter time periods as the rate of conversion increased with the power intensity provided by the 365 nm light used to irradiate the perovskite.

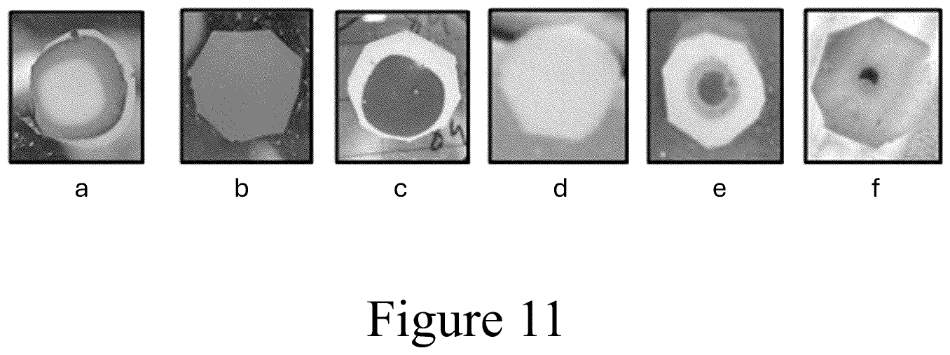

Visual images of the perovskite layers in different phases of hydration and the dynamics resulting from irradiating the perovskite are illustrated in FIG. 11, which demonstrates the accessibility of the 4× excess FAI sample following continuous irradiation using 365 nm light (see Panel (a) of FIG. 11), while the rest of the layer images correspond to samples tested using 0.4M 2.5× excess FAI. Panel (b) of FIG. 11 illustrates a prehydrated sample, which using the setup illustrated FIG. 7 was subsequently hydrated to yield the material illustrated in Panel (d) of FIG. 11. The layer was then irradiated with light and the α-phase reconfiguration began to grow outward, away from the center of the pump beam. Interestingly, rehydration (unsealing chamber) resulted in two separate α-phase zones as can be seen in material illustrated in Panel (e) of FIG. 11. Panel (f) of FIG. 11 illustrates a sample of a high intensity irradiated sample of perovskite.

Here coalescence or crystal aggregation commenced where even when hydrated, the a center remained and when dehydrated the δ edge remained unchanged.

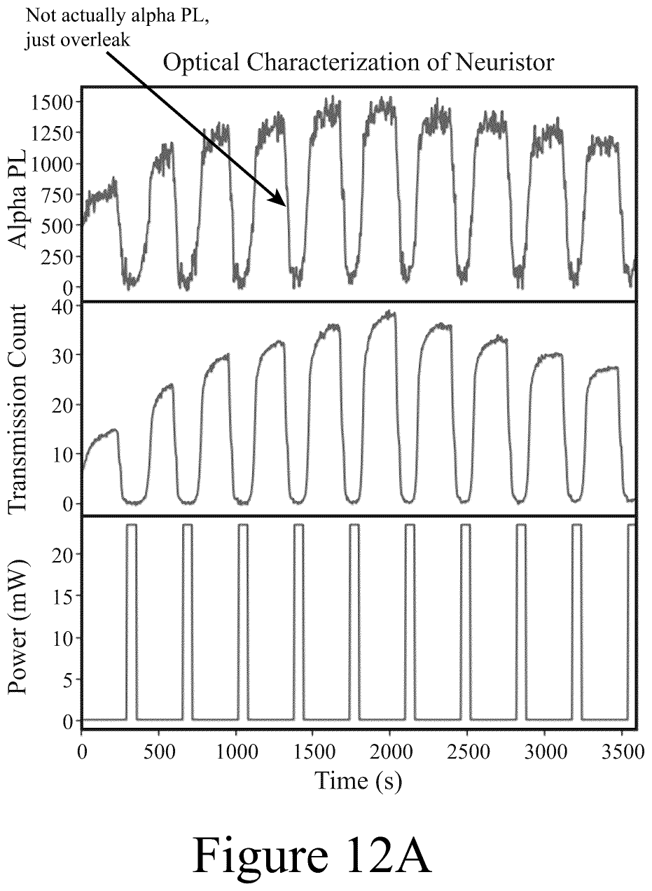

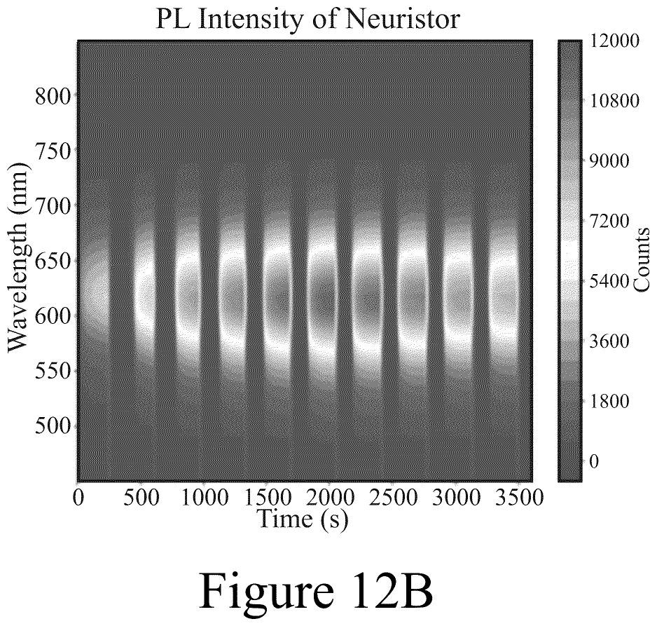

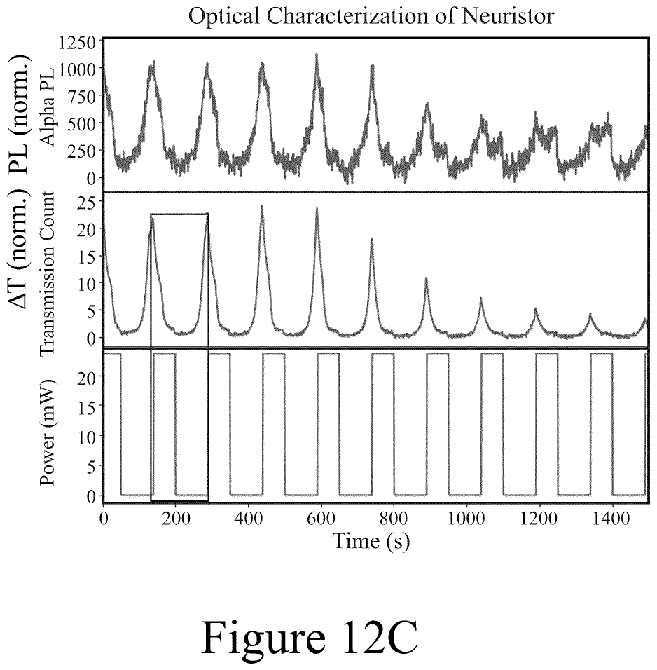

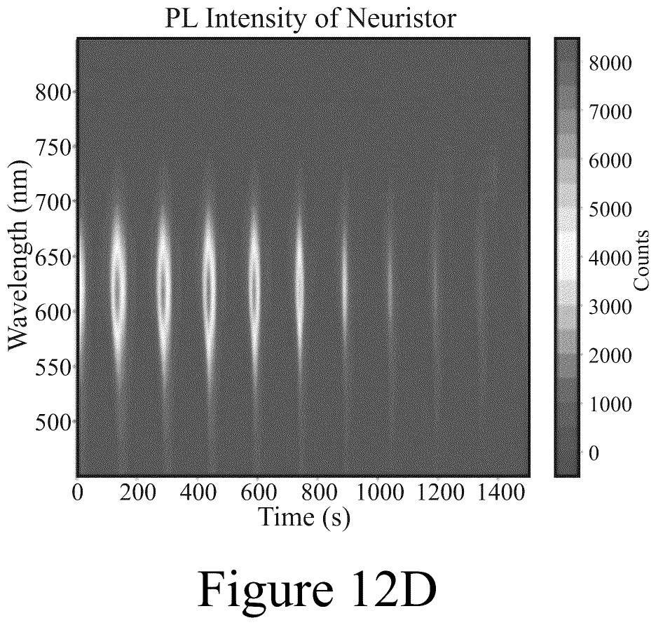

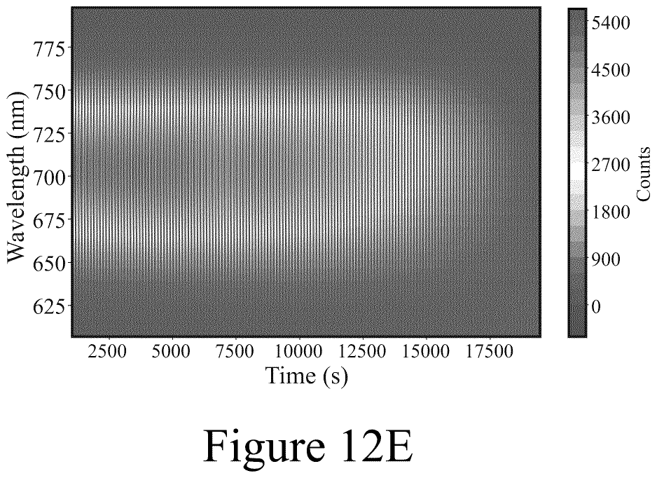

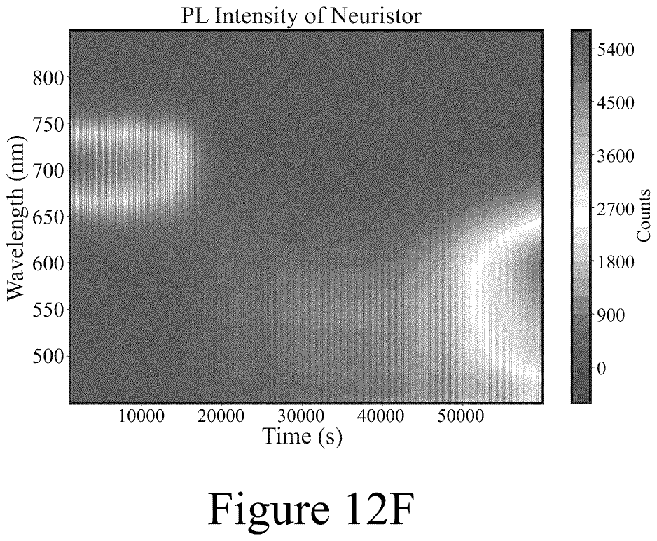

Next, the effect of multiple pulses of LED supplied light having a wavelength of 365 nm applied to the samples to simulate presynaptic spikes was studied. FIGS. 12A and 12B illustrate that 10 cycles of 1 minute of “light on” at 23.5 mW followed by 5 minutes of “light off” led to the threshold condition is not being met even though a complete transition to the α-phase is reached. Therefore, α emission at 700-750 nm was not seen as illustrated by the contour map of FIG. 12B. There was also an increase and subsequent decrease in overall transmission across the layer. Thus, in order to actually reach a firing threshold, the “light on” time either needed to be increased and/or the “light off” time decreased. FIGS. 12C and 12D illustrate that the time was changed so that the next pulse of UV light in the serios of pulses occurred before the complete reconfiguration or leakage back to the δ-phase. So, when a 1 minute “light on” at 23.5 mW and 1.5 minute “light off” in a series of pulses was used, threshold firing (i.e., PL) occurred and began to grow prominently around the 7^{th} pulse of light. To ascertain the capability for repeated firings, a series of 1 minute “light on” 47.5 mW followed by 1 min “light-off” was applied to a perovskite sample, with the results illustrated in FIGS. 12E and 12F. These pulses were relatively intense and well above the threshold of firing which leads to the conclusion that far more that the 150 cycles of continued α emissions would be able to exist if operated in a manner much closer to realistic conditions (like a stochastic neural network).

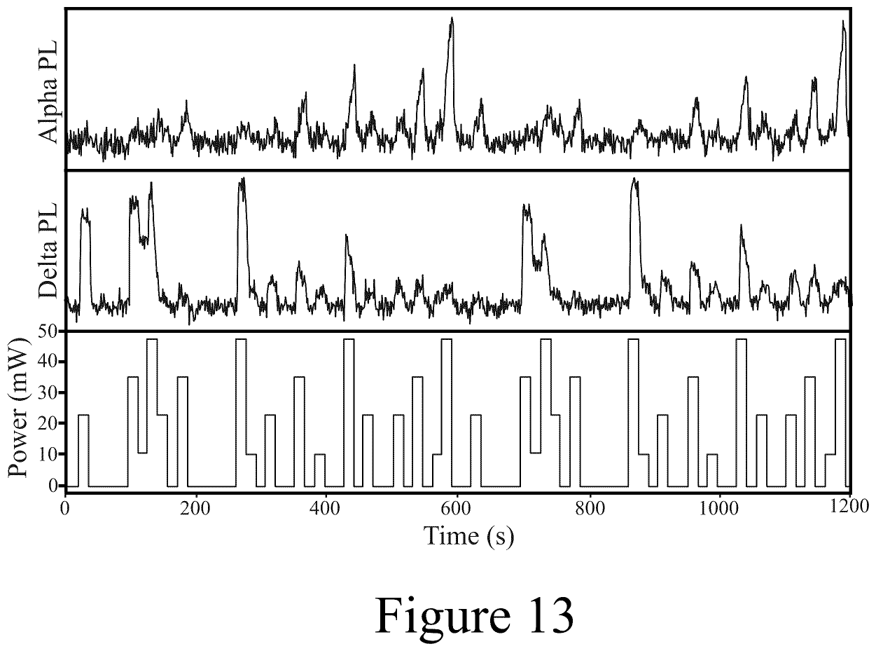

Regarding device applications in feasible systems of the future it is important to understand the ability to actually mimic neurological behavior in a stochastic neural network. So, to further investigate this, a pseudo stochastic succession of varying pulse intensities of 15 seconds “light on” was applied to a perovskite sample, with the results illustrated in FIG. 13. Here it can be seen that when some the combination of low frequency and lower power pulses are used δ-phase emission occurred, but when the intensity of the powers and/or pulse frequency were increased, the crystals in the layer reconfigured to α-phase where emission then began to occur around 710 nm. It should also be noted that forgetting reconfiguration was not only present but was replicated when the pulse train was repeated in the second half of the graphs where the same δ- and α-phase emission patterns were reproduced. Forgetting occurs when the emission wavelength reverts back to a prior wavelength due to reverting back to the delta phase.

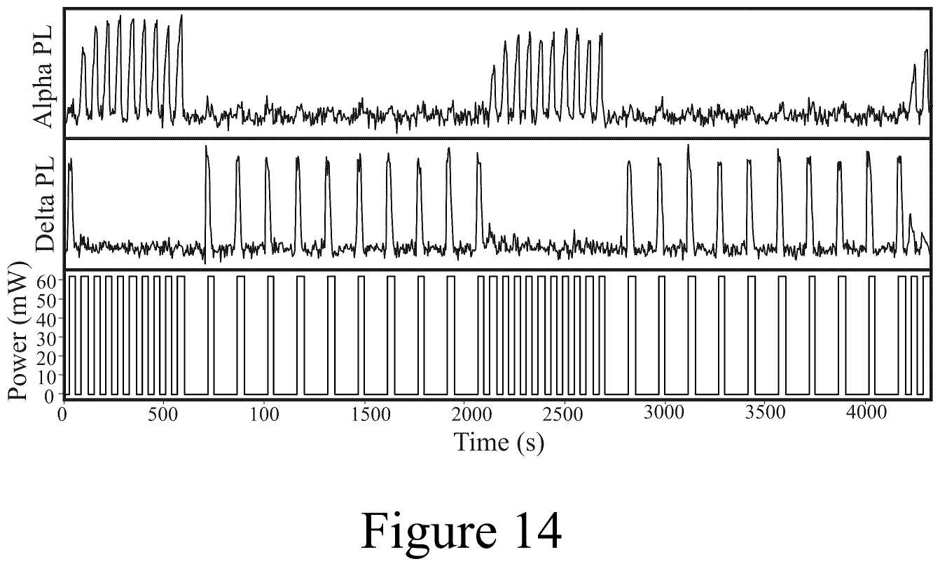

To better understand at forgetting, FIG. 14 illustrates the results obtained when using pulsing light to a perovskite ten time with 0.5 minutes “light on” at 34 mW followed by 0.5 minutes of “light off”, followed by 10 more pulses of light for 0.5 minutes “light on” at 34 mW and 2 min “light off”, the threshold of α-phase firing was attained only after conversion to the α-phase was achieved. Following the increase in off time duration, only 6 emission occurred until the frequency in pulses was increased again. This is repeatable in nature and produced the same presynaptic patterns.

### Experimental

### Thin-Film Preparation

Substrate Preparation: Glass microscope coverslips of 0.1 mm thickness are sonicated in isopropyl alcohol for 10 minutes. The coverslips are then dried using nitrogen gas flow before placement into a nitrogen atmosphere glovebox.

Scaffolding: Thin-films of alumina scaffolding are prepared by spin coating 157.1 uL solution of 16 wt % Al₂O₃ onto coverslips at 3000 rmp for 30 seconds in an Ossila vacuum-free spincoater under nitrogen atmosphere to yield an 820 nm thick scaffolding. The alumina scaffolding is then annealed at 100° C. for 5 minutes, also under nitrogen atmosphere. The thin-film scaffolds are then baked in an oven for 25 minutes at 500° C. Samples are then UV-ozone treated for 10 minutes immediately before transferring back into the nitrogen glovebox.

Perovskite Inks: Perovskite inks are made by preparing a 0.4M 2.5:1 excess ratio of FAI to PbI₂ in 2-methoxy ethanol (2-ME) under nitrogen atmosphere. Ink is allowed to sit for 3 days as degradation of FAI by 2-ME is required for device functionality as described in the Results section of the main text. 138 μL of the perovskite ink is then spincoated onto the alumina scaffolding thin-films using the Ossila vacuum-free spincoater at 4000 rpm for 30 seconds with a 5 second ramp. Directly after spincoating samples are annealed at 100° C. for 10 minutes. After samples have been annealed they are immediately removed from the nitrogen atmosphere and are stored in a dark, low-humidity environment.

### Optical Switching

Preparation: To prepare the alumina+perovskite thin-films for optical switching excess material is scraped from the perimeter of coverslip using a razor blade with minimal pressure to be roughly the size of the spot size produced from the 365 nm ThorLabs LED which is approximately a 1 cm diameter circle in the center of the coverslip. Any residue from perovskite ink is then removed from the sample (usually the reverse side) with isopropyl alcohol.

Humidification: Humidification of the sample is done by placing the coverslip in a standard ThorLabs sample holder between two glass windows and o-rings with 15 μL of saturated potassium chloride KCL inserted between the o-ring and the thin-film side of the coverslip. This maintains a relative humidity of ~84% at 25° C. and stabilizes the delta-phase of the FAPbI₃ thin-films.

Optical Setup: Optical switching Is carried out using a Keysight 81150A 120 MHz Pulse Function Arbitrary Generator to send signal to a ThorLabs DC2200 Laser Driver to modulate the pump parameters of the 365 nm ThorLabs LED. A ThorLabs White Light is also employed to monitor transmission of light across the thin-film. Photoluminescece and transmission are then collected using an OceanOptics Spectrophotometer utilizing OceanView software to capture data.

### EXAMPLES

Example 1. A method comprising: reversibly switching a perovskite between a δ-phase and an α-phase, wherein: when the perovskite is substantially in the δ-phase, the perovskite is capable of absorbing light at a first wavelength and emitting light at a second wavelength and when the perovskite is substantially in the α-phase, the perovskite is capable of absorbing light at the first wavelength and emitting light at a third wavelength.

Example 2. The method of Example 1, wherein: the perovskite has a composition according to Aₙ₊₁BₙX₃ₙ₊₁, A is a first cation, B is a second cation, X is an anion, n can be reversibly transitioned between a first value of one and a second value of greater than one, the perovskite is substantially in the α-phase when n is greater than 7, and a mixture of the δ-phase and a two-dimensional (2D) crystalline phase is present when n is between 1 and 7, inclusively.

Example 3. The method of either Example 1 or Example 2, wherein n is equal to a number of corner-sharing octahedral sheets present in the 2D crystalline phase.

Example 4. The method of any one of Examples 1-3, wherein A comprises formamidinium (FA).

Example 5. The method of any one of Examples 1-4, wherein B comprises at least one of bismuth, antimony, copper, nickel, lead, tin, or a combination thereof.

Example 6. The method of any one of Examples 1-5, wherein X comprises at least one of a halide, a pseudohalide, or a combination thereof.

Example 7. The method of any one of Examples 1-6, wherein the halide comprises iodide, bromide, chloride, or a combination thereof.

Example 8. The method of any one of Examples 1-7, wherein the perovskite comprises FA, lead, and iodide.

Example 9. The method of any one of Examples 1-8, further comprising irradiating the perovskite with a light having the first wavelength, wherein the δ-phase emits light at the second wavelength.

Example 10. The method of any one of Examples 1-9, wherein the second wavelength is greater than the first wavelength.

Example 11. The method of any one of Examples 1-10, wherein the first wavelength is between 250 nm and 400 nm.

Example 12. The method of any one of Examples 1-11, wherein the second wavelength of light is between 495 nm and 570 nm.

Example 13. The method of any one of Examples 1-12, further comprising irradiating the perovskite with a light having the first wavelength, wherein the α-phase emits light at the third wavelength.

Example 14. The method of any one of Examples 1-13, wherein the third wavelength is greater than the second wavelength.

Example 15. The method of any one of Examples 1-14, wherein the third wavelength is between 450 nm and 750 nm.

Example 16. The method of any one of Examples 1-15, further comprising an intervening molecule and a mixture, wherein the mixture comprises the intervening molecule and at least one of the δ-phase, the α-phase, and the 2D crystalline phase.

Example 17. The method of any one of Examples 1-16, wherein the mixture is positioned within a porous solid.

Example 18. The method of any one of Examples 1-17, wherein the porous solid comprises a solid and pores and the mixture is positioned within the pores.

Example 19. The method of any one of Examples 1-18, wherein: the solid is configured to absorb light, the absorbed light heats the solid, and the heat is transferred from the solid to the mixture.

Example 20. The method of any one of Examples 1-19, wherein: the δ-phase exists when it is maintained at a first temperature, and the α-phase exists when it is maintained at a second temperature that is greater than the first temperature.

Example 21. The method of any one of Examples 1-20, wherein the first temperature is between 15° C. and 25° C.

Example 22. The method of any one of Examples 1-21, wherein the second temperature is between 25° C. and 150° C.

Example 23. The method of any one of Examples 1-22, wherein the solid is constructed of a metal oxide.

Example 24. The method of any one of Examples 1-23, wherein the porous solid is between 25 vol % and 99 vol % empty volume relative to the total volume.

Example 25. The method of any one of Examples 1-24, wherein the metal oxide comprises at least one of an alumina, a titania, a tin oxide, a nickel oxide, a zirconium oxide, zinc oxide or a combination thereof.

Example 26. The method of any one of Examples 1-25, wherein the alumina comprises Al₂O₃.

Example 27. The method of any one of Examples 1-26, wherein the titania comprises TiO₂.

Example 28. The method of any one of Examples 1-27, further comprising transmitting light from a light source to at least one of the perovskite, the solid, or a combination thereof via a first waveguide.

Example 29. The method of any one of Examples 1-28, wherein the first waveguide comprises at least one of a fiber optic cable or an element on a photonic integrated circuit.

Example 30. The method of any one of Examples 1-29, further comprising transmitting light emitted by the perovskite from the perovskite to a downstream device via a second waveguide.

Example 31. The method of any one of Examples 1-30, wherein the second waveguide comprises at least one of a fiber optic cable or an element on a photonic integrated circuit.

Example 32. The method of any one of Examples 1-31, wherein the light from the light source is provided in pulses defined by a first period of time with the light on and a second period of time with the light off.

Example 33. The method of any one of Examples 1-32, wherein first period of time is between 0.1×10⁻³ seconds and 100 seconds.

Example 34. The method of any one of Examples 1-33, wherein second period of time is between 0.1×10⁻³ seconds and 5 minutes.

Example 35. The method of any one of Examples 1-34, further comprising, cooling the perovskite from the second temperature to the first temperature.

Example 36. The method of any one of Examples 1-35, wherein the cooling is achieved by placing at least one of the perovskite, the porous solid, or a combination thereof in physical conduct with a thermally conducting material.

Example 37. The method of any one of Examples 1-36, wherein the porous solid containing the mixture is in the form of a layer having a thickness between 15 nm and 10 μm.

Example 38. The method of any one of Examples 1-37, wherein light irradiating the material has a power input between 1×10⁻⁶ mW and 100 mW.

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, +0.3%, ±0.2%, or ±0.1% of a specific numeric value or target.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each e. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A method comprising:
reversibly switching a perovskite between a δ-phase and an α-phase, wherein:
when the perovskite is substantially in the δ-phase, the perovskite is capable of absorbing light at a first wavelength and emitting light at a second wavelength, and
when the perovskite is substantially in the α-phase, the perovskite is capable of absorbing light at the first wavelength and emitting light at a third wavelength.

2. The method of claim 1, wherein:
the perovskite has a composition according to Aₙ₊₁BₙX₃ₙ₊₁,
A is a first cation, B is a second cation, X is an anion,
n can be reversibly transitioned between a first value of one and a second value of greater than one,
the perovskite is substantially in the α-phase when n is greater than 7, and
a mixture of the δ-phase and a two-dimensional (2D) crystalline phase is present when n is between 1 and 7, inclusively.

3. The method of claim 2, wherein n is equal to a number of corner-sharing octahedral sheets present in the 2D crystalline phase.

4. The method of claim 2, wherein the perovskite comprises FA, lead, and iodide.

5. The method of claim 1, further comprising irradiating the perovskite with a light having the first wavelength, wherein the δ-phase emits light at the second wavelength.

6. The method of claim 5, further comprising irradiating the perovskite with a light having the first wavelength, wherein the α-phase emits light at the third wavelength.

7. The method of claim 3, further comprising an intervening molecule and a mixture, wherein the mixture comprises the intervening molecule and at least one of the δ-phase, the α-phase, and the 2D crystalline phase.

8. The method of claim 7, wherein the mixture is positioned within a porous solid.

9. The method of claim 8, wherein the porous solid comprises a solid and pores and the mixture is positioned within the pores.

10. The method of claim 18, wherein:
the δ-phase exists when it is maintained at a first temperature, and
the α-phase exists when it is maintained at a second temperature that is greater than the first temperature.

11. The method of claim 10, wherein the first temperature is in a range between 15° C. and 25° C.

12. The method of claim 10, wherein the second temperature is in a range between 25° C. and 150° C.

13. The method of claim of 9, wherein the solid is constructed of a metal oxide.

14. The method of claim 13, wherein the porous solid is between 25 vol % and 99 vol % empty volume relative to the total volume.

15. The method of claim 13, wherein the metal oxide comprises at least one of an alumina, a titania, a tin oxide, a nickel oxide, a zirconium oxide, zinc oxide or a combination thereof.

16. The method of claim 1, further comprising transmitting light from a light source to at least one of the perovskite, the solid, or a combination thereof via a first waveguide.

17. The method of claim 16, further comprising transmitting light emitted by the perovskite from the perovskite to a downstream device via a second waveguide.

18. The method of claim 16, wherein the light from the light source is provided in pulses defined by a first period of time with the light on and a second period of time with the light off.

19. The method of claim 10, further comprising, cooling the mixture from the second temperature to the first temperature.

20. The method of claim 19, wherein the cooling is achieved by placing at least one of the mixture, the porous solid, or a combination thereof in physical conduct with a thermally conducting material.
